(19) United States
(12) Patent Application Publication
(10) Pub. No.: US 2016/0229711 A1
(43) Pub. Date: Aug. 11, 2016

(54) RESIN REGENERATION METHOD FOR REDUCING ORGANIC CONTAMINANTS

(71) Applicant: Purolite Corporation, Bala Cynwyd, PA (US)

(72) Inventors: Francis Boodoo, King of Prussia, PA (US); Stephen Moylan, Hatfield, PA (US)

(21) Appl. No.: 15/021,868

(22) PCT Filed: Sep. 5, 2014
(86) PCT No.: PCT/US2014/054217

§ 371 Date: Mar. 14, 2016

Related U.S. Application Data
(60) Provisional application No. 61/879,499, filed on Sep. 18, 2013.

(51) Int. Cl. C02F 1/42; B01J 49/00

(52) U.S. Cl. CPC C02F 1/42; B01J 49/0073; B01J 49/0013; C02F 2303/16; C02F 2101/30

(57) ABSTRACT

The present invention relates generally to regeneration of ion exchange resins and more particularly to regeneration using low concentrations of brine to remove organic contaminants from the resin.

### CROSS-REFERENCE TO RELATED APPLICATION

This application claims priority to U.S. Provisional Application No. 61/879,499, filed Sep. 18, 2013, the contents of which are hereby incorporated by reference in its entirety.

### FIELD OF THE INVENTION

The present invention relates generally to regeneration of ion exchange resins and more particularly to regeneration using low concentrations of brine to remove organic contaminants from the resin.

### BACKGROUND OF THE INVENTION

A variety of processes are used to remove unacceptable levels of organic contaminants present in water. Organic contaminants are sometimes referred to as total organic carbon (TOC) and/or natural organic matter. Non-limiting examples of TOCs include humic acids, fulvic acids, tannins, and other organic compounds formed by degradation of plant residues and/or by various industrial processes such as pulping and paper making. In addition to natural and industrial TOC contamination commonly found in surface and subsurface water, recent research indicates that there are several other potentially health damaging organic compounds in water sources such as phthalates, bisphenol compounds, hormones, insecticides, herbicides, pharmaceutics, as well as illicit drug residues.

Removal of organic contaminants from water is necessary to provide high quality water suitable for distribution and consumption by humans, animals, and industrial processes. Effective process are also needed for purifying discharges from food processing, mining waste, transportation, sewage, and storm runoff. In addition, environmental regulations have been enacted to assure aesthetic appearance of public waterways by setting color standards for industrial discharges. TOC removal is also required for water intended for potable use in which oxidants are added before the water is distributed to consumers. Reaction between TOC present in water and oxidants can form disinfection byproducts (DBPs) at concentrations that exceed the maximum contaminant level (MCL) permitted by regulatory authorities. For example the United States EPA regulations mandate reduction of TOC in water intended for potable use by at least 35%, depending on the alkalinity in the water.

Most compounds and materials described as TOC are very hydrophilic and are not easily separable from water. A number of processes have been used in an effort to separate TOC contaminants and to make water medically and aesthetically acceptable. Examples of such processes include clarification (with the addition of various chemicals such as alum), adsorption by activated carbon and filtration by installation of ultrafiltration and microfiltration membranes ahead of a reverse osmosis (RO) membrane plant. Strong base anion exchange resins are also useful in removing organic matter such as humic and fulvic acid from water. The organic contaminants loaded on the resin must be periodically removed or eluted from the resin to allow for repeated use of the resin. Resin regeneration is typically achieved by passing a high concentration brine solution of sodium chloride through the resin bed. The organic contaminants are thought to be loaded onto the resin by adsorption and/or ion exchange. High concentrations of brine (approximately 10% or higher) are therefore considered necessary to provide sufficient shrinkage of the resin beads to slough off the large molecular weight organic materials from the surface of the beads. This process, which is sometimes referred to as a “brine squeeze,” uses the brine to “squeeze” the resin beads to release the organic materials. Typically, a dosage range of 8 to 10 lbs of NaCl per cubic foot of resin (128 to 160 grams NaCl per liter of resin) is needed per regeneration cycle, making TOC removal economically prohibitive in many cases. The quantity of commercial salt needed can be quite large for treatment of large volumes of water such as in municipal potable water treatment plants. For example, reducing TOC in a 20 MGD municipal plant (76,000 m³/day) will typically require about 5,000 tons of salt per year, with a typical cost of about $500,000 USD per year. In addition, tightening environmental regulations make it very difficult for plant operators to discharge such large quantities of salt to the environment. Moreover, organic contaminants are much larger than common inorganic ions and therefore tend to block and interfere with filtration and can cause fouling of RO membranes when the membranes are used to desalinate surface and waste water supplies. In particular, high molecular weight compounds such as humic and fulvic acids can significantly reduce the operating efficiency of water treatment plants, requiring more frequent cleaning and higher operating costs. Using a strong base anion exchange resin to reduce the TOC ahead of the RO would protect the membranes from organic fouling, but the cost of using commercial salt for periodic regeneration of the resin can often times makes the project uneconomical.

Accordingly, the systems and processes provided herein help satisfy the ongoing need for a simple, direct, readily operable, and low cost process for removal of organic contaminates from water.

### SUMMARY OF THE INVENTION

A new environmentally friendly method of purifying feed water containing organic contaminants is now provided.

One embodiment provides a method of purifying feed water containing organic contaminants comprising:

passing a volume of the feed water through a vessel containing an anion exchange resin component; and

periodically regenerating the anion exchange resin component by removing organic contaminants from the resin by passing a volume of regenerant solution through the vessel,

wherein the regenerant solution comprises a concentration of total dissolved solids (TDS) of about 0.25% to about 1%.

In one embodiment, the regenerant solution comprises a waste water stream isolated from a water purification process, such as a reject stream from a reverse osmosis membrane plant; a reject stream from a forward osmosis membrane plant; spent regenerant from an ion exchange process; blowdown from evaporative cooling towers; concentrate from thermal, vacuum, and vapor recompression evaporators. The ion exchange process is a demineralization, dealkalization, nitrate removal, or ion exchange softening process. The regenerant solution can also comprise naturally occurring water streams (such as brackish or produced water streams).

In one embodiment, the resin in the vessel containing the anion exchange component comprises a standard anion exchange resin. This resin may be, for example, a macroporous-type resin containing quaternary ammonium functionality and an acrylic matrix (such as PUROLITE A860).

Water containing any variety of organic contaminants may be purified using the methods disclosed herein, including organic contaminants such as humic acids, fulvic acids, tannins, and the like. The organic contaminants may be complexed with colloidal particulates, such as colloidal particulates comprising clay, silica, aluminum, iron, or combinations thereof; or substantially free of bound colloidal particulates.

The regenerant solution can comprise a solution of sodium chloride (or brine). In one embodiment, the regenerant solution is an aqueous sodium chloride solution comprising less than or equal to about 0.5% sodium chloride (or about 0.5% or less than about 0.5%, 0.4%, 0.3%, or 0.25% sodium chloride). In some embodiments, the regenerant solution consists essentially of about 0.5% sodium chloride.

In one embodiment, the regeneration method reduces a total organic carbon bound to the resin by at least 2% or more (or at least about 5%, 10% or 20% or more). In one embodiment, the purification method reduces the total organic carbon of the feed water by at least about 50% or at least about 95% or more. In some embodiment, the feed water comprises a total organic carbon of about 3 ppm or greater or about 6 ppm or greater.

The regenerant solution may flow through the ion exchange component in the same direction as the flow of feed water or in a direction opposite from the flow of the feed water.

In another embodiment of the present invention, a method of regenerating a resin in a membrane water treatment system is provided. This method comprises:

recovering water concentrated as a waste stream from the membrane treatment system, and

regenerating the resin in the membrane treatment system by flowing the waste stream through the resin,

wherein the waste steam comprises a concentration of total dissolved solids of about 0.25% to about 1%, and wherein the regenerating reduces a total organic carbon bound to the resin by at least 5% or more.

This method may be such that the regeneration reduces a total organic carbon bound to the resin by at least about 10% or about 20% or more.

The system may contain any of a variety of apparatus for filtering or otherwise cleaning produced or brackish water. In one embodiment, the system comprises an ion exchange apparatus coupled to a reverse osmosis, forward osmosis, nanofiltration, electrodialysis or purification system. In one embodiment, the waste stream of this system may include the reject stream generated from a reverse osmosis, forward osmosis or electrodialysis membrane. In one embodiment, the system comprises an ion exchange apparatus coupled to a thermal, vacuum or vapor recompression evaporator system. In one embodiment, the waste stream of this system may include the concentrate bottom streams from thermal, vacuum or vapor recompression evaporator systems. In one embodiment, the waste stream of this system may include the concentrated blowdown stream from cooling towers. In one embodiment, the waste stream of this system may include the waste regenerant streams from ion exchange systems such demineralizer, dealkalizer, softener, nitrate removal, or other selective contaminant ion exchange systems (e.g. for removal of arsenic, chromium, fluoride, barium strontium, radium, uranium, and perchlorate). In one embodiment the waste stream of this system may include the blowdown from boilers. In one embodiment the waste stream of this system may include naturally occurring brackish or produced water, provided the TDS of the water is within the range as indicated above.

### BRIEF DESCRIPTION OF THE DRAWINGS

FIGS. 1A and 1B depict the results of an experiment in which PUROLITE A860 Resin was regenerated with 0.5% Brine

### DETAILED DESCRIPTION

The present invention makes use of dilute solutions of sodium chloride (or brine) as well as the salt naturally present in the brackish or produced water or waste streams (e.g., waste streams from membranes, ion exchange plants, cooling towers and boiler blow-down streams), allowing operators of ion exchange water purification systems to:

(1) reduce and preferably eliminate the cost associated with the purchase and handling of large amounts of bulk salt for regeneration of the ion exchange resins,
(2) achieve lower levels of organic contaminants in water treated by the invention that previously were considered unattainable for dilute salt regenerated resins, and/or
(3) minimize and preferably eliminate additional burden on the environment from discharge of commercial salt.

In general, the present process is applicable to the removal of organic contaminants from water streams containing the organic contaminants. It is particularly effective for the treatment of inland water as well as water that is readily transportable to an ocean, sea or other large salt water body for disposal. As defined herein, the term “feed water,” will designate the water streams to be treated by the present process. Such feed waters include surface water, ground water, waste waters, including field drainage and urban waste water, and aqueous waste from the operation of evaporative cooling towers and certain processes of industry and energy conversion. The term feed water also includes water which has undergone prior processing, e.g., ultrafiltration, microfiltration, sand or multimedia filtration, clarification, chemical precipitation softening, manganese greensand filtration, ion exchange softening, carbon or anthracite filtration, ion exchange demineralization, thermal or vacuum evaporation, reverse osmosis, forward osmosis or electrodialysis, before treatment herein. In general, the feed water streams to which the present invention is applicable include a variety of organic contaminants. Total Organic Carbon (TOC) is a common way of expressing the combined concentration of all organics present in the water. Non-limiting examples of TOC commonly found in water include humic acids, fulvic acids, tannins, and other organic compounds formed by degradation of plant residues and/or by various industrial processes. In addition to natural and industrial TOC contamination other potentially health damaging organic compounds in water sources such as phthalates, bisphenol compounds, hormones, insecticides, herbicides, pharmaceutics, endocrine disruptor chemicals, fluoropolymers, as well as illicit drug residues are also included in the scope of the invention.

In some embodiments, the organic contaminants can be complexed with colloidal particulates. Non-limiting examples of colloidal particulates include clay, silica, aluminum, iron, or combinations thereof. In some embodiments, the organic contaminants are substantially free of bound colloidal particulates.

In some embodiments, the feed water comprises a total organic carbon of 3 ppm or greater, or 4, 5, 6, 7, 8, 9, 10 ppm or greater. In some embodiments, the feed water comprises a total organic carbon of 5-10, or 7-15, or 10-30 ppm or greater. In some embodiments, the feed water comprises a total organic carbon of 6 ppm or greater.

On passing the feed water through a vessel containing an ion exchange resin component, the TOC from the feed water is at least partially reduced. The term “ion exchange resin” is intended to broadly describe polymer resin particles which have been chemically treated to attach or form functional groups which have a capacity for ion exchange. The term “functionalize” refers to processes (e.g. sulfonation, haloalkylation, amination, etc.) for chemically treating polymer resins to attach ion exchange groups, i.e. “functional groups”. The polymer component serves as the substrate or polymeric backbone whereas the functional group serves as the active site capable of exchanging ions with a surrounding fluid medium. The present invention also includes a class of ion exchange resins comprising crosslinked copolymers including interpenetrating polymer networks (IPN). The term “interpenetrating polymer network” is intended to describe a material containing at least two polymers, each in network form wherein at least one of the polymers is synthesized and/or crosslinked in the presence of the other polymer. The polymer networks are physically entangled with each other and in some embodiments may be also be covalently bonded. Characteristically, IPNs swell but do not dissolve in solvent nor flow when heated. Ion exchange resins including IPNs have been commercially available for many years and may be prepared by known techniques involving the preparation of multiple polymer components.

As used herein, the term “polymer component” refers to the polymeric material resulting from a polymerization reaction. For example, in one embodiment of the present invention, the ion exchange resins are “seeded” resins; that is, the resin is formed via a seeded process wherein a polymer seed is first formed and is subsequently treated with monomer and subsequently polymerized. Additional monomer may be subsequently added during the polymerization process. The monomer mixture used during a polymerization step need not be homogeneous; that is, the ratio and type of monomers may be varied. The term “polymer component” is not intended to mean that the resulting resin have any particular morphology. However, the present resins may have a “core-shell” type structure as is described in U.S. Publication No. 2013/0085190, the entire contents of which are incorporated herein by reference.

Examples of suitable crosslinking agents include monomers such as polyvinylidene aromatics such as divinylbenzene, divinyltoluene, divinylxylene, divinylnaphthalene, trivinylbenzene, divinyldiphenyl ether, divinyldiphenylsulfone, as well as diverse alkylene diacrylates and alkylene dimethacrylates. Preferred crosslinking monomers are divinylbenzene, trivinylbenzene, and ethylene glycol dimethacrylate. The terms “crosslinking agent,” “crosslinker” and “crosslinking monomer” are used herein as synonyms and are intended to include both a single species of crosslinking agent along with combinations of different types of crosslinking agents.

The polymer particles of the present invention can also be prepared by suspension polymerization of an organic phase comprising, for example, monovinylidene monomers such as styrene, crosslinking monomers such as divinylbenzene, a free-radical initiator and, optionally, a phase-separating diluent. The polymer may be macroporous or gel-type. The terms “gel-type” and “macroporous” are well-known in the art and generally describe the nature of the copolymer particle porosity. The term “macroporous” as commonly used in the art means that the copolymer has both macropores and mesopores. The terms “microporous,” “gellular,” “gel” and “gel-type” are synonyms that describe polymer particles having pore sizes less than about 20 Angstroms while macroporous polymer particles have both mesopores of from about 20 to about 500 Angstroms and macropores of greater than about 500. In some embodiments, the macroporous resin of the invention has a pore diameter range of 500-100,000 Angstroms, and the specific volume of the pores ranges from 0.5-2.1 cc/g.

When using an anion-exchange resin, the capacity for removal of negatively charged dissolved organic matter is increased significantly. The term “anion-exchange resin” indicates a resin which is capable of exchanging negatively charged species with the environment. The term “strong base anion exchange resin” refers to an anion exchange resin that comprises positively charged species which are linked to anions such as Cl⁻, Br⁻, F⁻ and OH⁻. The most common positively charged species are quaternary amines and protonated secondary amines. Suitable anion-exchange resins include resins whose matrix is either hydrophilic or hydrophobic including anion-exchange resins wherein the exchanging groups are strongly or weakly basic in either gel or macroporous forms. Preferably, the matrix is polystyrene or polyacrylic, gel form, particularly based on polystyrene/divinylbenzene copolymer. Anion exchange resins may include strong base anion exchange resins (SBA), weak base anion exchange resins (WBA) and related anionic functional resins, of either the gelular or macroporous type containing quaternary ammonium functionality (chloride, hydroxide or carbonate forms), dialkylamino or substituted dialkylamino functionality (free base or acid salt form), and aminoalkylphosphonate or iminodiacetate functionality, respectively. In some embodiments, the anion exchange resin is a macroporous type resin containing quaternary ammonium functionality. In some embodiments, the anion exchange resin comprises an acrylic matrix. In some embodiments, the anion exchange resin is a PUROLITE A860 resin, a strong base macroporous acrylic resin with resin bead diameters ranging from 300 to 1200 microns, with a theoretical exchange capacity of 0.8 equivalent per liter of resin, with a moisture content of 66 to 72 percent. In some embodiments, the anion exchange resin is similar to PUROLITE A500P, a macroporous polystyrenic strong base anion exchange resin with resin bead diameters ranging from 300 to 1200 microns with a theoretical exchange capacity of 0.8 equivalent per liter of resin, with a moisture content of 63 to 72 percent. In some embodiments, the anion exchange resin is similar to PUROLITE PFA400, a gel polystyrenic strong base anion exchange resin with resin bead diameters ranging from 520 to 620 microns with a theoretical exchange capacity of 1.3 equivalent per liter of resin, with a moisture content of 48 to 54 percent. In some embodiments, the anion exchange resin is similar to PUROLITE SSTA64FL, a gel polystyrenic Type 1 “shallow-shell” strong base anion exchange resin with resin bead diameters ranging from 500 to 1000 microns with a theoretical exchange capacity of 2.7 equivalent per liter of resin, with a moisture content of 43-51 percent. In some embodiments, the anion exchange resin is similar to PUROLITE A870, a macroporous acrylic mixed base anion exchange resin with both strong and weak base functionality, with resin bead diameters ranging from 300 to 1200 microns with a theoretical exchange capacity of 1.25 equivalent per liter of resin, with a moisture content of 56 to 62 percent. In some embodiments, the anion exchange resin is similar to PUROLITE A847, a macroporous polystyrenic strong base anion exchange resin with resin bead diameters ranging from 300 to 1200 microns with a theoretical exchange capacity of 1.6 equivalent per liter of resin, with a moisture content of 56 to 62 percent. In some embodiments, the anion exchange resin is similar to PUROLITE PCA433, a gel polystyrenic strong base anion exchange resin with resin bead diameters ranging from 150 to 300 microns with a theoretical exchange capacity of 1.3 equivalent per liter of resin, with a moisture content of 48 to 57 percent.

Periodically, it is necessary to regenerate the resin component to remove the organic contaminants retained on the resin. Such regeneration requires a regenerant solution capable of displacing organic compounds from the ionic exchange resin. To reduce the TOC in feed water, methods in the prior art typically require a liquid brine regenerant solution which is usually made up onsite from dry sodium chloride or similar chloride salts purchased either in the form of rock or solar salt. The accepted practice is to use a brine concentration of 10% or higher, or salt dosage of usually 15-25 lb/ft³ of resin. Another method in prior art typically requires the joint use of brine and caustic, typically in a solution of 10% sodium chloride and 2% sodium hydroxide. However, Applicants surprisingly discovered that low concentrations of brine of about 0.5% or less are sufficient, once steady-state operation is achieved, for eluting a significant fraction of organic matter from select ion exchange resins, allowing for repeated service use of the resin and minimum depreciation in organic removal performance.

In some embodiments, the regenerant comprises one or more chloride salts such as potassium, calcium, or ammonium chloride, or an alkali or base, such as caustic potash, ammonium carbonate and sesquicarbonates of sodium or potassium. In another embodiment, the regenerant comprises a chloride brine solution (e.g. sodium chloride).

In some embodiments, the regenerant solution comprises about 5% sodium chloride, or about 4.5, 4.0, 3.5, 3.0, 2.5, 2.0, 1.5, 1.0, 0.5, 0.4, 0.3, 0.25, 0.2, 0.125% sodium chloride. In some embodiments, the regenerant solution comprises about 0.5% sodium chloride. In some embodiments, the regenerant solution comprises less than 0.5% sodium chloride or less than about 0.4, 0.3, 0.25, 0.2, 0.125% sodium chloride.

In some embodiments, the regenerant solution consists essentially of about 5% sodium chloride, or about 4.5, 4.0, 3.5, 3.0, 2.5, 2.0, 1.5, 1.0, 0.5, 0.4, 0.3, 0.25, 0.2, 0.125% sodium chloride. In some embodiments, the regenerant solution consists essentially of about 0.5% sodium chloride. In some embodiments, the regenerant solution consists essentially of less than 0.5% sodium chloride or less than about 0.4, 0.3, 0.25, 0.2, 0.125% sodium chloride. As used herein, the term “consists essentially of” (and grammatical variants) means that the regenerant solution comprises no other agents which change the material characteristics of the composition. The term “consists essentially of” does not exclude the presence of other components such as minor impurities, solvents, and the like.

Other regenerants include salts of either sodium, potassium or ammonium combined with one of chloride, bicarbonate, carbonate, or nitrate.

In some embodiments, the sodium chloride solution is warmed before treating the resin. In some embodiments, the brine is warmed up to about 95 to about 140° F. In some embodiments, the sodium chloride solution added to the resin at room temperature.

Regeneration may be performed continuously on a portion of the resin removed from the vessel for the filtration step while filtration continues with the remainder of the resin followed by recycling of the regenerated resin. Alternatively, regeneration may be performed during periodic shutdown of the resin bed. In some embodiments, at least one pair of ion exchange columns are loaded with the same volumes of resin with one ion exchange column in service removing the TOC from the feed water while the other column is off-line and being regenerated with the corresponding volume reject generated by regenerated by the membrane plant.

Conventional processing conditions, such as the frequency of regeneration, concentration of the regenerant streams and ratio of regenerant to feed water, may vary to a significant extent depending upon the type of feed water to be processed. However, while not intending to be bound by theory, it is believed that the volume and concentration of total dissolved solids (TDS) of the brine used for regeneration must be matched to quantity of TOC in the feed water that is treated, in order to provide enough of a driving force to elute the organic materials and other anionic species like sulfate from the resin. In some embodiments, for example, Applicants have found that about two equivalents of regenerant sodium chloride at a concentration of 0.5% is sufficient to consistently elute about 3000 mg of TOC from one liter of resin.

On passage of the brine through the resin organic contaminants are displaced. The resins can either be operated in co-flow mode, with the water and brine entering and exiting the ion exchange vessel in the same direction, or in counter-flow mode, with water and brine entering the vessel in opposite directions. In a preferred embodiment, counter-flow is preferred as the freshest brine makes first contact with the volume of resin at the end of the vessel from which the softened water exits when the vessel is next placed into service. This means that the resin where the brine enters gets maximum regeneration efficiency and residual contaminants left over in the resin will be at a minimum. When the vessel is put into service, the water leaving the vessel makes last contact with this highly regenerated resin and thus desorption of contaminants (i.e. leakage) into the water during the next service cycle is kept to a minimum. Counter-flow operation can therefore use a lower dosage of salt compared to co-flow operation.

In some embodiments, the regeneration step reduces the TOC bound to the resin by at least 1% or more. In some embodiments, the regeneration step reduces the TOC bound to the resin by at least 1.5, 2, 3, 4, 5, 6, 7, 8, 9, 10, or 20% or more. In some embodiments the TOC bound to the resin is reduced by at least 2-5, 5-10, 7-15, 15-45, or 50% or more. In some embodiments, the TOC bound to the resin is reduced by at least 75 or 95% or more during the regeneration step. Applicants have surprisingly discovered that even small reductions in TOC on the resin (e.g., 2-5% reductions) during the regeneration step can afford a steady state by which enough TOC is removed from the resin to provide open binding sites in the resin to allow for efficient removal of organic contaminants from the feed water through several regeneration cycles.

In some embodiments, the inventive method reduces the TOC of the feed water by at least 10% or more. In some embodiments, the purification process reduces the TOC of the feed water by at least 15, 20, 25, 30, 50, 75, or 95% or more. In other embodiments, the TOC content of the water is reduced to 0.5-2 ppm, or 1, 2, 3, 4, 5, ppm. Reducing the TOC content to 1 to 2 ppm or lower is highly desirable to minimize membrane plant downtime and improve plant reliability.

In some embodiments, the resin is used for the treatment of water being fed to a membrane treatment system. The membrane treatment system can be, for example, a reverse osmosis membrane system, a forward osmosis membrane treatment system, or a nanofiltration membrane system. In some embodiments, the membrane system can be configured such that a volume of feed water is passed through a vessel containing an ion exchange resin component. The vessel may be any container known in the art that can contain the resin component at the pressure required in the system. In some embodiments, the vessel is a glass column. The water is then optionally routed through a 5 micron filter or similar filter for removal of any last traces of suspended solids before it is fed to a reverse osmosis or other type of membrane system.

Applicants have discovered that it is highly desirable to treat a specific volume of feed water used by a reverse osmosis or similar membrane plant and use the corresponding volume of reject water generated by the membrane plant to regenerate the resin. For example, in some embodiments, the water concentrated as a blowdown stream (or reject water) from the membrane plant is collected and used to regenerate the resin by flowing the blowdown stream through the resin. This has the advantage of reducing and preferably eliminating the cost associated with the purchase and handling of large amounts of bulk salt for regeneration of the softeners. In this embodiment, the blowdown stream comprises less than or equal to about 0.5% sodium chloride. In some embodiments, the blowdown stream comprises about 5% sodium chloride, or about 4.5, 4.0, 3.5, 3.0, 2.5, 2.0, 1.5, 1.0, 0.5, 0.4, 0.3, 0.25, 0.2, 0.125% sodium chloride. In some embodiments, the regenerant solution comprises less than 0.5% sodium chloride or less than about 0.4, 0.3, 0.25, 0.2, 0.125% sodium chloride. In some embodiments, the blowdown stream consists essentially of about 5% sodium chloride, or about 4.5, 4.0, 3.5, 3.0, 2.5, 2.0, 1.5, 1.0, 0.5, 0.4, 0.3, 0.25, 0.2, 0.125% sodium chloride. In some embodiments, the blowdown stream consists essentially of about 0.5% sodium chloride. In other embodiments, the regeneration reduces the TOC bound to the resin by at least 1% or more. In some embodiments, the regeneration step reduces the TOC bound to the resin by at least 1.5, 2, 3, 4, 5, 6, 7, 8, 9, 10, or 20% or more. In some embodiments the TOC bound to the resin is reduced by at least 2-5, 5-10, 7-15, 15-45, or 50% or more. In some embodiments, the TOC bound to the resin is reduced by at least 75 or 95% or more during the regeneration step.

### ABBREVIATIONS AND DEFINITIONS

The following abbreviations are used throughout the specification:

### TOC Total Organic Carbon

### BV Bed Volume

### TDS Total Dissolved Solids

### SBA Strong Base Anion Exchange Resin

### WBA Weak Base Anion Exchange Resin

### SAC Strong Acid Cation Exchange Resin

### WAC Weak Acid Cation Exchange Resin

### IPN Interpenetrating Polymer Network

Unless defined otherwise, all technical and scientific terms used herein generally have the same meaning as commonly understood by one of ordinary skill in the art to which this invention belongs. Generally, the nomenclatures used herein are those well-known and commonly employed in the art. The techniques and procedures are generally performed according to conventional methods in the art and various general references. The nomenclature used herein and the procedures in water purification and polymer chemistry described herein are those well-known and commonly employed in the art.

As used herein, the term “counter-flow,” when used for resin regeneration, means that the water being treated by the resin and the brine used for regeneration of the resin enter and leave the ion exchange apparatus in opposite directions.

As used herein, the term “co-flow,” when used for resin regeneration, means that the water being treated by the resin and the brine used for regeneration of the resin enter and leave the ion exchange apparatus in the same direction.

The term “about” or “approximately” means within an acceptable error range for the particular value as determined by one of ordinary skill in the art, which will depend in part on how the value is measured or determined—e.g., the limitations of the measurement system, or the degree of precision required for a particular purpose. For example, “about” can mean within 1 or more than 1 standard deviations, as per the practice in the art. Alternatively, “about” can mean a range of up to 20%, preferably up to 10%, more preferably up to 5%, and more preferably still up to 1% of a given value. Where particular values are described in the application and claims, unless otherwise stated, the term “about” meaning within an acceptable error range for the particular value should be assumed.

As used herein and in the appended claims, the singular forms “a,” “an,” and “the,” include plural referents unless the context clearly indicates otherwise. Thus, for example, reference to “a molecule” includes one or more of such molecules, “a resin” includes one or more of such different resins and reference to “the method” includes reference to equivalent steps and methods known to those of ordinary skill in the art that could be modified or substituted for the methods described herein.

All U.S. patents and published applications and other publications cited herein are hereby incorporated by reference in their entirety.

### EXAMPLES

### Example 1

### Regeneration of PUROLITE A860 Resin with 0.5% Brine

Spent brine containing 33,000 ppm TOC and 8% NaCl was collected from a customer site where PUROLITE A860 resin was being used for TOC removal from drinking water. The TOC composition was a mixture of humic and fulvic acids that is typical of drinking water installations across the USA (about 70% of the organic compounds in the water have a molecular weight range from about 500 to 3000, about 20% of the organic compound in the water have a molecular weight of about 500 and about 10% of the organic compounds in the water have a molecular weight greater than about 3000). The spent brine containing the TOC was prepared for use as a feed solution to the virgin resin by diluting with demineralized water to a TOC content of 16 ppm and a sodium chloride (NaCl) content of 36 ppm. A total of 40 mL (approximately 29 grams wet) PUROLITE A860 strong base anion exchange resin in the chloride was loaded into a 0.5 inch (1.27 cm) diameter glass and loaded to a height of 12 inches (31 cm). A total of 250 bed volumes (10 L) of feed solution was passed through the resin at a service flowrate of 40 BV/hr (27 mL/min).

All of the effluent retrieved from the resin was collected and a 1 L composite of the solution was retained and analyzed by TOC analysis. The resin was then rinsed with 4 BV (160 mL) of demineralized water at a flow rate of 2 BV/h. The resin was then regenerated in counter-flow mode with 20 bed volumes of 0.5% brine at a rate of 40 BV/hr. ASC certified reagent quality NaCl was used to make a 0.5% brine solution using demineralized water. All of the effluent retrieved from the regeneration step was collected and analyzed by TOC analysis. The resin was then rinsed with 4 BV deionized water and the conductivity of the effluent was monitored.

The above process was repeated for 56 TOC loading and removal cycles. The data obtained during each cycle is shown in Table 1.

TABLE 1

| | | | | TOC | | Net |
|---|---|---|---|---|---|---|
| | Inlet | | | eluted | % TOC | Cumulative |
| | TOC in | TOC | TOC | with 0.5% | eluted | TOC loaded |
| | feed | out | loaded | brine | from | on resin |
| Cycle # | (ppm) | (ppm) | (mg) | (mg) | resin | (mg) |
| 1 | 16.1 | 0.36 | 157 | 6 | 4% | 151 |
| 2 | 16.9 | 0.25 | 166 | 8 | 5% | 309 |
| 3 | 15.8 | 0.17 | 156 | 11 | 7% | 455 |
| 4 | 18.4 | 0.22 | 181 | 13 | 7% | 623 |
| 5 | 17.0 | 0.29 | 168 | 28 | 17% | 762 |
| 6 | 17.3 | 0.08 | 172 | 25 | 14% | 910 |
| 7 | 16.9 | 0.22 | 167 | 18 | 11% | 1059 |
| 8 | 16.9 | 1.04 | 158 | 47 | 30% | 1171 |
| 9 | 17.8 | 0.38 | 174 | 25 | 15% | 1319 |
| 10 | 19.3 | 0.18 | 192 | 36 | 19% | 1475 |
| 11 | 18.0 | 0.15 | 178 | 28 | 16% | 1625 |
| 12 | 16.5 | 0.26 | 163 | 96 | 59% | 1692 |
| 13 | 16.8 | 0.15 | 166 | 44 | 27% | 1814 |
| 14 | 18.1 | 0.33 | 178 | 40 | 23% | 1951 |
| 15 | 18.4 | 0.72 | 176 | 49 | 28% | 2079 |
| 16 | 17.8 | 0.34 | 174 | 43 | 25% | 2210 |
| 17 | 18.5 | 0.15 | 184 | 80 | 44% | 2313 |
| 18 | 18.6 | 0.22 | 184 | 46 | 25% | 2451 |
| 19 | 18.1 | 2.10 | 160 | 43 | 27% | 2569 |
| 20 | 15.9 | 0.16 | 157 | 62 | 39% | 2664 |
| 21 | 18.0 | 0.30 | 177 | 68 | 39% | 2772 |
| 22 | 17.2 | 1.20 | 160 | 339 | 212% | 2594 |
| 23 | 17.0 | 3.14 | 138 | 38 | 28% | 2694 |
| 24 | 16.2 | 0.15 | 160 | 72 | 45% | 2782 |
| 25 | 17.6 | 1.16 | 165 | 46 | 28% | 2901 |
| 26 | 18.9 | 0.52 | 184 | 48 | 26% | 3038 |
| 27 | 17.6 | 0.47 | 171 | 108 | 63% | 3100 |
| 28 | 18.3 | 0.47 | 178 | 76 | 43% | 3202 |
| 29 | 17.8 | 0.48 | 173 | 152 | 88% | 3223 |
| 30 | 18.7 | 0.35 | 184 | 111 | 61% | 3296 |
| 31 | 16.8 | 2.57 | 142 | 68 | 48% | 3369 |
| 32 | 17.5 | 0.41 | 171 | 96 | 56% | 3445 |
| 33 | 17.1 | 0.52 | 165 | 118 | 71% | 3492 |
| 34 | 17.9 | 0.16 | 178 | 97 | 55% | 3573 |
| 35 | 17.7 | 0.22 | 175 | 61 | 35% | 3687 |
| 36 | 16.9 | 0.14 | 168 | 60 | 35% | 3795 |
| 37 | 16.6 | 0.27 | 163 | 68 | 42% | 3891 |
| 38 | 17.1 | 1.48 | 156 | 80 | 51% | 3967 |
| 39 | 17.6 | 0.29 | 173 | 99 | 57% | 4041 |
| 40 | 16.9 | 0.33 | 166 | 118 | 71% | 4088 |
| 41 | 14.2 | 0.10 | 141 | 38 | 27% | 4191 |
| 42 | 15.3 | 0.21 | 150 | 70 | 47% | 4271 |
| 43 | 40.8 | 1.21 | 396 | 185 | 47% | 4483 |
| 44 | 39.4 | 2.00 | 374 | 199 | 53% | 4658 |
| 45 | 39.6 | 2.26 | 373 | 286 | 77% | 4745 |
| 46 | 54.2 | 4.61 | 496 | 358 | 72% | 4883 |
| 47 | 40.6 | 6.09 | 345 | 279 | 81% | 4949 |
| 48 | 43.5 | 1.44 | 294 | 236 | 80% | 5007 |
| 49 | 15.7 | 0.58 | 121 | 143 | 118% | 4986 |
| 50 | 16.1 | 0.79 | 153 | 134 | 88% | 5005 |
| 51 | 14.5 | 1.40 | 131 | 105 | 80% | 5030 |
| 52 | 15.0 | 0.79 | 128 | 127 | 99% | 5031 |
| 53 | 15.8 | 1.48 | 143 | 112 | 78% | 5062 |
| 54 | 15.4 | 2.65 | 127 | 153 | 120% | 5037 |
| 55 | 15.4 | 2.33 | 131 | 138 | 105% | 5030 |
| 56 | 16.1 | 2.79 | 133 | 132 | 100% | 5031 |

The above data demonstrates that TOC loaded onto an A860 column can be efficiently removed with dilute 0.5% brine and rinsed to conductivity. As shown, the regeneration process can withstand several loading/regeneration cycles achieving a viable steady state environment.

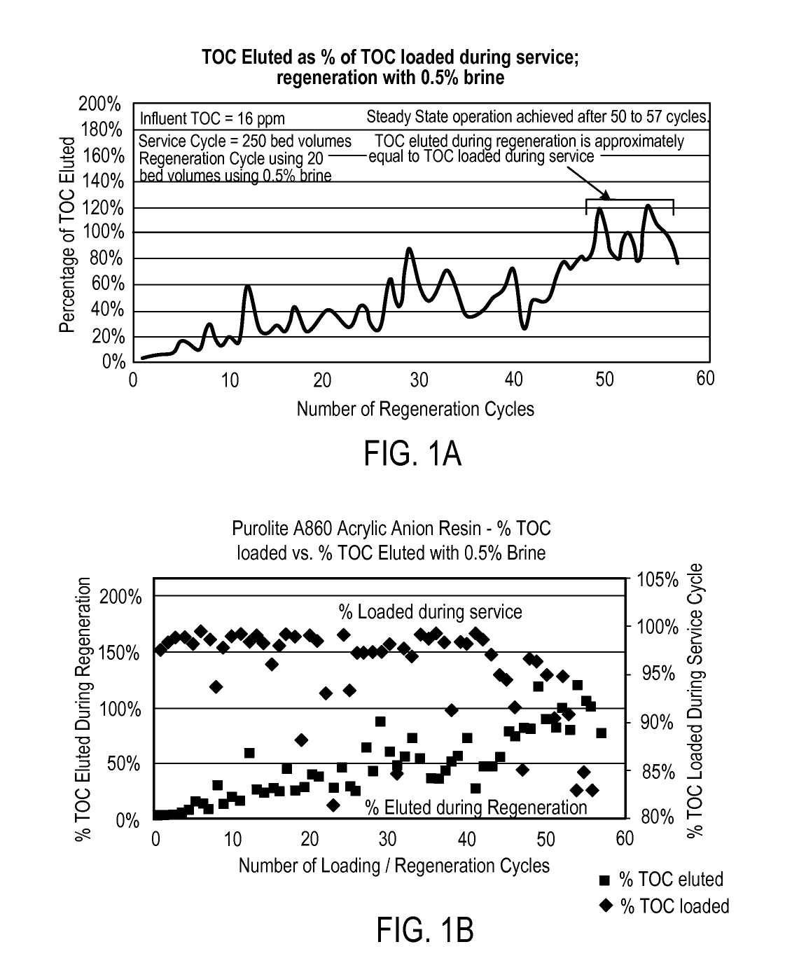

As shown in Table 1 and depicted graphically in FIGS. 1A and 1B, in the initial service/regeneration cycles more TOC was bound to the resin than could be eluted with each subsequent regeneration step using 0.5% brine. Surprisingly, Applicants discovered that after 57 cycles of service and regeneration the resin had achieved steady state operation, during which period the amount of TOC loaded during each service cycle was about equal to that eluted during each subsequent regeneration. Not to be bound by theory, it is believed that the higher molecular weight fractions of the TOC, eventually fouls and binds tightly to the resin, making it difficult to elute this fraction with very dilute brine. However, it appears that a sufficient amount of the lower molecular weight fraction is elutable by dilute brine, making it practical to use such dilute brines for partial TOC removal from the resin.

What is claimed is:

1. A method of purifying feed water containing organic contaminants comprising:
passing a volume of the feed water through a vessel containing an anion exchange resin component; and
periodically regenerating the anion exchange resin component by removing organic contaminants from the resin by passing a volume of regenerant solution through the vessel,
wherein the regenerant solution comprises a concentration of total dissolved solids of about 0.25% to about 1%.

2. The method of claim 1, wherein the regenerant solution comprises a waste water stream isolated from a water purification process.

3. The method of claim 2, wherein the waste water stream is selected from the group consisting of a reject stream from a reverse osmosis membrane plant; a reject stream from a forward osmosis membrane plant; spent regenerant from an ion exchange process; blowdown from evaporative cooling towers; and concentrate from thermal, vacuum, or vapor recompression evaporators.

4. The method of claim 3, wherein the ion exchange process is a demineralization, dealkalization, nitrate removal, or ion exchange softening process.

5. The method of claim 1, wherein the regenerant solution comprises naturally occurring water streams.

6. The method of claim 5, wherein the naturally occurring water streams comprise brackish or produced water streams.

7. The method of claim 1, wherein the anion exchange resin is a macroporous-type resin containing quaternary ammonium functionality.

8. The method of claim 1, wherein the resin comprises an acrylic matrix.

9. The method of claim 1, wherein the organic contaminants comprise humic acids, fulvic acids, or tannins.

10. The method of claim 9, wherein the organic contaminants comprise humic acids.

11. The method of claim 9, wherein the organic contaminants comprise fulvic acids.

12. The method of claim 1, wherein the organic contaminants are complexed with colloidal particulates.

13. The method of claim 12, wherein the colloidal particulates comprise clay, silica, aluminum, iron, or combinations thereof.

14. The method of claim 1, wherein the organic contaminants are substantially free of bound colloidal particulates.

15. The method of claim 1, wherein the regenerant solution comprises essentially of about 0.5% sodium chloride.

16. The method of claim 1, wherein the regenerant solution comprises about 0.5% sodium chloride.

17. The method of claim 1, wherein the regenerant solution comprises about 0.4% sodium chloride.

18. The method of claim 1, wherein the regenerant solution comprises less than about 0.25% sodium chloride.

19. The method of claim 1, wherein the regeneration reduces a total organic carbon bound to the resin by at least 2% or more.

20. The method of claim 1, wherein the regeneration reduces a total organic carbon bound to the resin by at least 5% or more.

21. The method of claim 1, wherein the regeneration reduces a total organic carbon bound to the resin by at least 10% or more.

22. The method of claim 1, wherein said purifying reduces a total organic carbon of the feed water by at least about 20% or more.

23. The method of claim 1, wherein said purifying reduces a total organic carbon of the feed water by at least about 50% or more.

24. The method of claim 1, wherein said purifying reduces a total organic carbon of the feed water by at least about 95% or more.

25. The method of claim 1, wherein the feed water comprises a total organic carbon of 1 ppm or greater.

26. The method of claim 1, wherein the feed water comprises a total organic carbon of 6 ppm or greater.

27. The method of claim 1, wherein said regenerating comprises passing the regenerant solution through the resin in the same direction as the feed water.

28. The method of claim 1, wherein said regenerating comprises passing the regenerant through the resin in the opposite direction as the feed water.

29. A method of regenerating an ion exchange resin in a membrane water treatment system comprising:
recovering water concentrated as a waste stream from the membrane treatment system, and
regenerating the resin in the membrane treatment system by flowing the waste stream through the resin,
wherein the waste steam comprises a concentration of total dissolved solids of about 0.25% to about 1%, and wherein the regenerating reduces a total organic carbon bound to the resin by at least 5% or more.

30. The method of claim 29, wherein the regeneration reduces a total organic carbon bound to the resin by at least 10% or more.

31. The method of claim 29, wherein the regeneration reduces a total organic carbon bound to the resin by at least 20% or more.

32. The method of claim 29, wherein the membrane water treatment system comprises a reverse osmosis, forward osmosis, or nanofiltration purification system.

33. The method of claim 29, wherein the membrane water treatment system comprises a reverse osmosis purification system.

34. The method of claim 29, wherein the blowdown stream is a reject stream generated from a reverse osmosis membrane.
